(19) United States
(12) Patent Application Publication
(10) Pub. No.: US 2012/0296732 A1
(43) Pub. Date: Nov. 22, 2012

(54) POINT OF SALE SYSTEM FOR RETAIL, HAVING AUTOMATIC INCLUSION OF PRICE REDUCTIONS IN A FLEXIBLE MANNER WHILE PROTECTING CUSTOMER DATA

(75) Inventor: Rainer Gläss, Schöneck (DE)

(73) Assignee: Valuephone GmbH, Schöneck (DE)

(21) Appl. No.: 13/576,314

(22) PCT Filed: Jan. 31, 2011
(86) PCT No.: PCT/EP2011/051315

§ 371 Date: Jul. 31, 2012

(30) Foreign Application Priority Data
Feb. 4, 2010 (EP) 10152694.5

(51) Int. Cl. G06Q 30/02

(52) U.S. Cl. 705/14.38

(57) ABSTRACT

The invention relates to a point of sale system comprising a point of sale device (1) having input devices (3) for recording external customer identification codes and for identifying articles, and having a point of sale data processing device (2) calculating an amount to be paid as a function of the article identifications, and a data processing system (20) coupled to the point of sale data processing device by means of a data transfer network (12), comprising a first (24) and a second server (21, 22). The first server stores price reduction data sets comprising price reduction data set identifiers, each identifying a price reduction associated with an article identifier, and each of which can be associated with first internal customer identification codes, wherein the first internal customer identification codes are identical to the external customer identification codes or can be uniquely calculated therefrom, and receives the external customer identification code by means of the data transfer network, and derives the associated first internal customer identification code and associated price reduction data sets, using the external customer identification code, and sends same back to the point of sale data processing device, said device then including said data when calculating the amount to be paid. The second server comprises article lists comprising customer data and associates the customer data with a second internal customer identification code, derives article identification data from the article lists and makes said data available for access by a data processing device (11) of a discount provider, without allowing said provider access to the customer data and the second internal customer identification code, and receives data from the discount provider specifying price reductions of the at least one article in the article list, transmits said data associated with data identifying the affected articles to the first server, said first server storing said data as price reduction data sets, and causes the price reduction data sets stored in the first server to be associated with first internal customer identification codes, wherein said second server derives the first internal customer identification codes from the second internal customer identification codes. Only the second server and the point of sale data processing device can access the first server.

The invention relates to a point of sale system for retail, comprising at least one point of sale device of a retailer comprising a point of sale data processing device and input devices for recording an article identification of at least one article, wherein the point of sale data processing device calculates an amount to be paid as a function of the at least one recorded article identification and a data processing system coupled to the point of sale data processing device via a data transfer network, where point of sale data processing device takes into account price reduction data when calculating the amount to be paid.

Known from the patent specification DE 44 33 569 B4 is an electronic paperless coupon system that allows the issue and redemption of an electronic coupon inside a shop without the need to print out the coupon on paper. The system described in this document is installed inside the shop of a retailer. A communications unit comprising a control console and a screen is fixed to a shopping trolley. As he walks through the shop, coupon data are displayed to the customer on the screen, where in particular those coupons are displayed which relate to goods located in the vicinity of the whereabouts of the shopping trolley. The coupons specify price reductions of these goods. If the customer would like to use such a coupon, he can select this during the display on the screen. The selected coupons (product identification and discount) are then stored in a file of the communications unit. The communications unit can then communicate with the point of sale device via an interface. When the customer is located at the point of sale and the goods located in the shopping trolley are scanned by a scanner, the point of sale automatically allows for the coupon discount from the file received by the communications unit. This known system has various disadvantages. It is restricted to a shop, requires additional technology on each shopping trolley (which is associated with considerable costs) and only allows the discount coupon to be selected by the customer when walking round the shop.

Known from the patent specification DE 696 20 451 T2 is a “system and method for providing shopping aids and incentives to customers through a computer network”. The document describes a method for coupon transmission (method for distributing “purchasing incentives) in which a customer firstly logs in from his computer via a data communication network to a remote central computer where an individual customer identification is assigned to him. In so doing, the customer inputs personal data. A plurality of “incentive offers” are then transferred to the computer of the registered customer, which can be executed in the area in which the customer resides. The customer selects from these incentive offers, with this selection being transmitted back to the central computer. The central computer then generates coupons (purchasing incentives) with the identification of a retailer selected by the customer and the identification of the customer in coded form and transmits these coupons to the customers. The customer then prints out the coupons and can then use these for his shopping at the associated retailers. The method has the disadvantage that it is restricted to one supplier of incentives or coupons (discount provider) and offers no data protection for the customer since the discount provider acquires complete knowledge of the identification data of the customer (during registration). A further disadvantage is that the coupons must be printed out and carried by the customer when shopping. Printing out means an additional obstacle for the customer. It is also feasible that the customer inadvertently does not take the coupons with him so that these cannot be taken into account during the planned shopping.

The “electronic couponing method and apparatus” described in the patent specification DE 697 37 655 T2 has similar disadvantages.

Starting from the said prior art, it is an object of the invention to provide a point of sale system for retail, that can automatically allow for price reductions of a plurality of discount providers, which enables automatic redemption when shopping at any retailers and additionally allows the price reduction offers of the discount providers to be adapted to the purchasing wishes of the customers whilst at the same time keeping the customer data anonymous.

This object is solved according to the invention by a point of sale system having the features of claim 1.

The point of sale system for retail according to the invention comprises at least one point of sale system and a data processing system coupled via a data transfer network (for example, the internet or a mobile phone network). The point of sale device comprises a point of sale data processing device and input devices for recording an external customer identification code and for recording an article identification of at least one article, where the point of sale data processing device calculates an amount to be paid as a function of the at least one recorded article identification. The point of sale data processing device receives an external customer identification code recorded by the point of sale data processing device, determines price reduction data sets using the received customer identification code, which each identify a price reduction of an article associated with an article identifier, and sends these price reduction data sets back to the point of sale data processing device, so that the point of sale data processing device can take into account the received price reduction data sets when calculating the amount to be paid. The article identifier of the price reduction data sets can fundamentally be the same as the article identification recorded by the point of sale device. At least the point of sale data processing device must be able to determine an article identification from the article identifier of the received price reduction data sets which can be compared with the recorded (for example, by the scanner) article identification of the purchased article. Price reduction is here intended to mean quite generally any discount or bonus which leads to a reduction in the amount to be paid. The price reduction or bonus can be an absolute amount of money or a percentage. The data processing system comprises a first and a second server device. A server device should be understood here as one or more servers which are located on one computer or can be distributed over several computers. The first server device stores price reduction data sets containing price reduction data set identifiers which can each be associated with one or more first internal customer identification codes. This means that the customer identification codes are either included in the price reduction data set or associated with this, whereby for example the price reduction data set identifiers are associated with the customer identification codes in separate data structures. The first internal customer identification codes are either the same as the external customer identification codes or can be calculated uniquely from these. The first server device receives the recorded external customer identification code via the data transfer network, determines the relevant first internal customer identification code and relevant price reduction data sets using the received external customer identification code, and sends the price reduction data sets back to the point of sale data processing device. Naturally, the sent price reduction data sets need not correspond physically to the price reduction data sets stored in the first server device; on the contrary, a logic content agreement is sufficient. The data processing system further comprises a second server device coupled to the first server device, which records customer data comprising article lists associated with the customer where the article lists identify the articles desired by the customer, and a second internal customer identification code is assigned to the customer data. These article lists can contain designations input by the customer for articles which he desires; however, this can also comprise designations selected by the customer from predefined designations. The articles desired by the customer preferably comprise those which the customer would like to purchase during an impending shopping trip at one or more different retailers. This can, for example, comprise article categories such as, for example, “bread” or “shampoo” or names of a certain article of a certain supplier. The second server device derives article identification data from the article lists which it makes available for access by a data processing device of a discount provider, without allowing said discount provider access to the customer data (including the original article lists) and the second internal customer identification code. The second server device receives data from the discount provider which specifies price reductions of at least one article, which corresponds (in its type) to an article contained in the article list. In addition, the discount provider can naturally also transmit data which specify price reductions of other articles, which do not correspond to articles contained in the article lists. The discount provider can comprise the retailer himself, a central office of a group of retailers, a manufacturer of the article or a separate bonus program provider who provides bonus programs for several retailers. The second server device transmits the data specifying the price reductions associated with data identifying the affected articles to the first server device which stores these data as price reduction data sets. Here it is also possible that the price reduction data sets are already generated by the second server device and are transmitted to the first server device. However, it is also feasible that the price reduction data sets are generated by the first server device from the data transmitted by the second server device. The second server device also causes the price reduction data sets stored in the first server device to be associated with first internal customer identification codes where said server device derives the first internal customer identification codes from the second internal customer identification codes. The second internal customer identification codes can be different from the first internal customer identification code, where a unique assignment must be given. In one preferred embodiment, the first internal customer identification codes are the same as the second internal customer identification codes and the internal customer identification codes are calculated uniquely from the external customer identification codes. This can be accomplished, for example, by the external customer identification codes being derived by a special encryption method from the internal customer identification codes. In this case, the external customer identification codes accessible to the retailer are encrypted internal customer identification codes, where the retailer is not able to determine the internal customer identification codes from the external customer identification codes. To this end, the first server device of the data processing system receiving the external customer identification code is preferably only in a position to do this. The first server device can only be accessed by the second server device and the point of sale data processing device. Here, access by the point of sale data processing device is restricted to the transmission of the external customer identification code and receipt of the price reduction data sets; the point of sale data processing device has no access to the internal customer identification code. The data processing device of the discount provider also exclusively has the aforesaid access to the second server device.

The point of sale system according to the invention dispenses with demanding discount coupons from the customer which had previously been transmitted to him. On the contrary, the point of sale system according to the invention merely receives an external customer identification code from the customer and uses this to retrieve all the relevant coupons (price reduction data sets) via a computer network from a server device of a data processing system. This relieves the customer of the burden of administering coupons and bringing the coupons to the retailer. Accordingly, data protection is achieved in relation to the customer data since the retailer neither administers customer data nor can he examine this data in the point of sale system according to the invention. As a result of the access of the discount provider, which can comprise the retailer or a company cooperating with this retailer, to the article identification data derived from the article lists, the retailer or the discount provider can take account of the purchasing wishes of the customer when compiling the price reduction data sets despite the restrictions of data protection.

A preferred embodiment of the point of sale system according to the invention is characterised in that identifiers of associated retailers are additionally associated with the price reduction data sets. In this case, in addition to the external customer identification code, the first server device also receives an identifier of the retailer from the point of sale data processing device and determines the price reduction data sets to be sent back to the point of sale data processing device using the received identifier of the retailer. In addition to the data specifying the price reductions, the second server device additionally receives data from the discount provider which specifies associated retailers. The second server device then transmits the data specifying price reductions also associated with data identifying the associated retailer to the first server device. This advantageous further development avoids price reduction data sets being transmitted to a point of sale data processing device of a retailer which do not affect him. This is particularly desirable if the first server device stores price reduction data sets which on the one hand are associated with the same customer identification code but on the other hand are associated with different retailers.

A further preferred further development of the point of sale system according to the invention is characterised in that the first server device receives no recorded article identifications from the point of sale data processing device and using the received external customer identification code, determines all the associated price reduction data sets independently of the associated article identifiers and sends these data sets back to the point of sale data processing device. In this case, the point of sale data processing device initially receives all the price reduction data sets associated with the customer, from which the point of sale data processing device selects those which correspond to the article identifications recorded by the input devices. In this way, the price reduction data sets can already be retrieved by the first server device after the external customer identification code has been recorded, but no article identification or not yet all the article identifications have been recorded (that is, all the articles have not yet been “scanned”). This makes it possible, for example, in the event that the customer still wishes to purchase another article at the last minute (shortly before paying) that this can not only be recorded but also the discount that may be available can be included directly in the calculation of the payment amount.

In another preferred further development of the point of sale system according to the invention, the second server device causes first internal customer identification codes to be associated with the price reduction data sets stored in the first server device, whereby the second server device retrieves the price reduction data sets and makes information contained therein available to a customer for retrieval so that the customer can observe this information (that is information about “coupons”) on a data communication device (for example, a mobile telephone or a PC) coupled to the second server device and then in response to the retrieval of the information by the customer transmits the first or second internal customer identification code to the first server device and causes this to assign first internal customer identification codes to the price reduction data sets. This embodiment is advantageous since this only allocates the “coupons” in the first server device to the customer when he has notified an interest in the coupons by invoking or requesting the coupon information. The coupons are not simply transmitted to the customer regardless of whether he desires a discount or not. The assignment of the internal customer identification codes to the price reduction data sets on the first server device is thereby accomplished by the intermediary of the second server device so that the customer does not receive any direct access to the first server device.

In a preferred embodiment of the point of sale system according to the invention, the data processing system comprises a third server device, where the third server device receives the external customer identification code and point of sale receipt data from the point of sale data processing device, which identify the purchased articles and the purchase price paid, and passes the point of sale receipt data associated with the customer identification code to the second server device. This has the advantage that the second server device which records the customer data, generates from the article list evaluations and provides them to discount providers, receives price reduction data from the discount providers and transmits the data required for the price reduction data sets in the first server device, now also has knowledge of the articles purchased by a customer and the purchase price paid for said articles. In this way, said server device can make the generation of coupon data dependent on this further information. In a preferred embodiment, the second server device then causes first internal customer identification codes to be associated with price reduction data sets stored in the first server device, in which the second server device compares the data identifying the purchased articles of the point of sale receipt data received from the third server device with the article identifiers of price reduction data sets of the first server device and if the identified articles agree, retrieves the price reduction data set and makes the information contained therein available to a customer for retrieval, so that the customer can observe the content of the price reduction data sets on a data communication device coupled to the second server device and can select the desired price reduction data sets. The second server device then transmits price reduction data set identifiers of the price reduction data sets selected by the customer together with the first or second internal customer identification code to the first server device and causes this server device to associate first internal customer identification codes with the corresponding price reduction data sets. In this procedure, the customer is therefore presented with price reduction data sets (coupons) as soon as the second server device has transmitted article identifiers to the first server device which agree with article identifiers of certain price reduction data sets (the so-called point of sale coupons) so that these price reduction data sets are then presented to the customer if he has previously purchased the identified articles.

In a preferred embodiment of the point of sale system according to the invention, the first and the second server device are disposed within an access-protected computer network (which is frequently designated as “demilitarized zone”—DMZ) where the data processing device of the discount provider and the data communication devices of the customer are disposed outside the access-protected computer network. This measure is also used for data protection and to avoid undesirable interventions.

In a preferred embodiment of the point of sale system according to the invention, the input devices of the point of sale device provided for recording the external customer identification code comprise a scanner which reads a barcode representing the external customer identification code produced on a mobile communication device of the customer. Preferably this scanner is used both for recording the external customer identification code and also for recording the article identification (in a conventional manner). Alternatively or additionally, the input devices for recording the external customer identification code can comprise an NFC communication device which executes a near field communication (NFC) with a mobile communication device (for example, mobile telephone) of the customer which stores the external customer identification code. This has the advantage that if the customer wished to pay at the point of sale, the point of sale device can automatically set up communication with the mobile communication device (the mobile telephone) of the customer in order to retrieve the customer identification code and then immediately begin the communication with the first server device.

In a preferred embodiment of the point of sale system according to the invention, the second server device is connected to a data processing device of the customer (for example his PC) via a data telecommunications network (for example, via the internet), from which the second server device receives customer data, where the customer data comprises inter alia data which identify articles desired by the customer. The data communication network is for example the internet, where the data processing device of the customer can, for example, comprise his PC. However, it is also feasible that the data communication network comprises a mobile phone network and the data processing device is a mobile telephone. The customer, for example inputs customer data via the keypad of his data processing device, which is then transmitted to the second server device. This customer data, for example, comprises a shopping list compiled by the customer which is transmitted to the second server device and is stored by said server device in a suitable format for a subsequent derivation of article identification data.

A preferred further development of the last-mentioned embodiment is characterised in that the second server device is connected to a mobile communication device (for example, a mobile telephone) of the customer via a data communication network, from which the second server device can receive data which identifies articles desired by the customer and to which the second server device can transmit data which identifies articles desired by the customer, where these data can be exchanged in such a manner that the data which is stored and can be displayed in the mobile communication device, which identifies articles desired by the customer agrees with the list of articles stored in the second server device. As a result, the article list which can be displayed on the mobile communication device of the customer (for example, the mobile telephone) is synchronized or continuously updated. If the customer, for example, has compiled or modified an article list on his home PC, he can then observe the correspondingly updated list on his mobile telephone.

A preferred embodiment of the point of sale system according to the invention is characterised in that the second server device records (and stores) an identifier by which means it is indicated whether the customer has released or blocked a relaying of the article list data to the discount provider. In this case, the second server device only provides article identification data derived from the article lists for access by a data processing device of the discount provider when the identifier releases this. By this means by an appropriate setting of the identifier (for example of a field content which can be modified by him or stored bits) it is possible for the customer to influence whether the data of his article lists (for example, shopping lists) can be used for the evaluation by discount providers or not.

In a preferred embodiment of the point of sale system according to the invention, the second server device comprises at least two servers. Each of these two servers can in turn consist of one or more servers which are located overall or in each case on one computer or on several computers. A first server of the second server device records the customer data with the article lists and assigns the second internal customer identification codes and causes the first internal customer identification code to be associated with the price reduction data sets stored in the first server device. The first server is therefore primarily used for recording the customer data and communication with the customers as well as for the transmission of data dependent on customer interactions to the first server device. A second server of the second server device provides the article identification data for access by a discount provider, receives data specifying price reductions from the discount provider and transmits these data specifying price reductions to the first server device. The second server is therefore preferably used for communication with the discount provider, in particular providing article identification data to the discount provider and receiving data of the discount provider, which specify price reductions. As a result of this separation in a first and a second server, additional security is achieved since customers on the one hand and discount providers on the other communicate with different servers.

Advantageous and/or preferred further developments of the invention are identified in the subclaims.

The invention is explained in detail hereinafter with reference to preferred embodiments shown in the drawings. In the drawings:

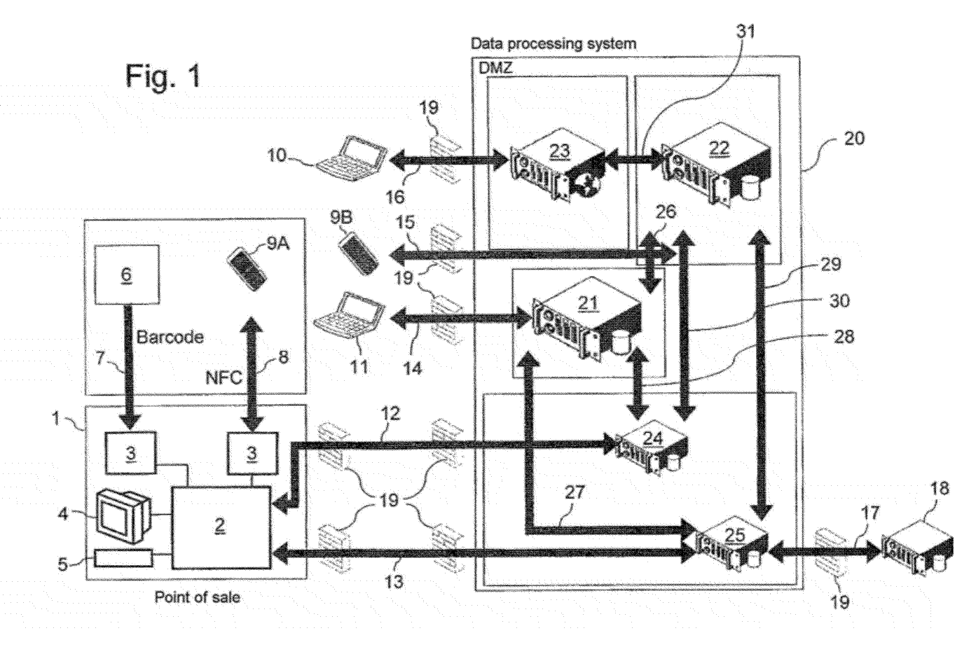

FIG. 1 shows an overview diagram of the essential components of the point of sale system according to the invention; and

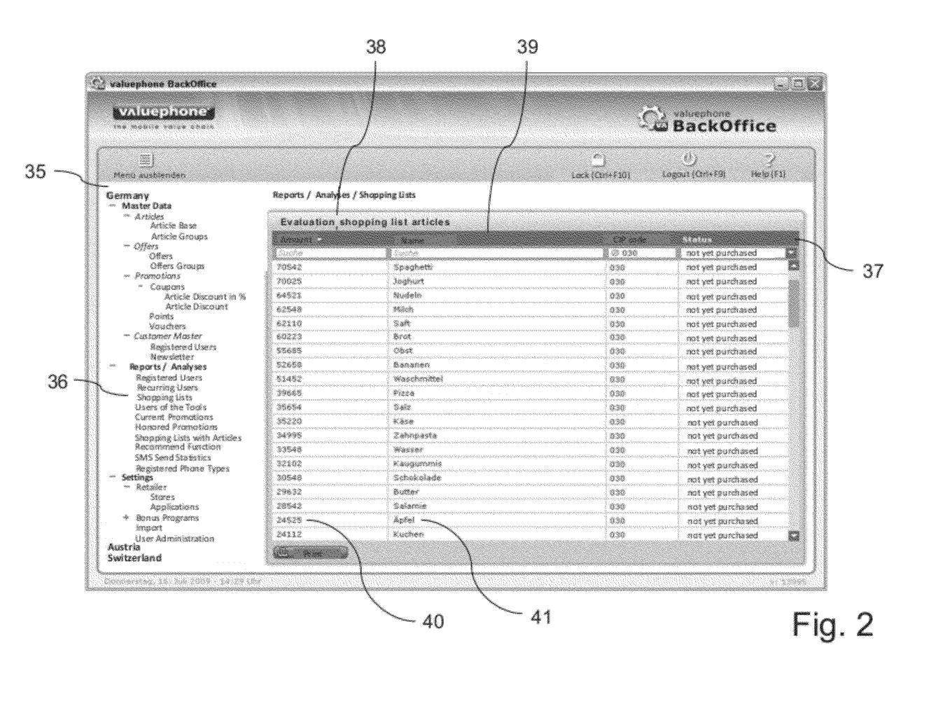

FIG. 2 shows a example screen shot which provides the article identification data derived from the article lists of the customers for a discount provider.

The point of sale system according to the invention shown schematically in FIG. 1 comprises a point of sale device 1 and a data processing system 20 coupled to the point of sale device 1. The point of sale device 1, which is located in a shop of a retailer, comprises a point of sale data processing device 2, to which a screen output 4 and a keypad 5 is coupled. The point of sale device 1 further contains input devices 3. One of the input devices 3 shown is coupled to a barcode reader 6 and receives a read barcode via an input line 7, where the barcode can comprise a barcode printed on a purchased article. A further input device 3 is a near field communication device (NFC=near field communication). By means of near field communication illustrated by the arrow 8, this input device 3 can, for example, communicate with a correspondingly equipped mobile telephone 9A of a customer. Naturally the point of sale device 1 contains further usual elements such as, for example, a conveyor belt for articles (goods) to be placed thereon, a money card reading device and a lockable point of sale compartment for receiving payment means.

The point of sale data processing device 2 calculates an amount to be paid as a function of the article identifications recorded, for example, by reading the barcode. If a barcode applied to an article is not readable, an article identification is usually recorded manually by means of the keypad 5. The screen 4 displays the recorded articles and the calculated amount to be paid. The payment is made, for example, in cash, where the amount of cash paid is recorded via an input device, for example, the keypad 5. However the payment can also be made cashless for example, by means of credit cards or by means of a specially secured transaction by means of a data processing device coupled for this purpose.

The barcode reader 6 can also be used to read a barcode produced on the mobile telephone 9A of the customer, where this barcode for example identifies the customer.

The point of sale device 1 is coupled to the data processing system 20 via a data transfer network. The data processing system 20 comprises a plurality of servers 21-25, which are arranged within an environment protected against unauthorised accesses, in particular within a DMZ (“Demilitarized Zone”). The various servers 21-25 communicate both with one another via predefined connections 27-31 and also with data processing systems outside the DMZ. The communication connections to the outside, for example, the connections 12-17, are secured by firewalls 19.

The point of sale data processing device 2 of the point of sale device 1 is connected via a connection 12 to a first server 24, which is subsequently designated as promotion server. The promotion server 24 stores price reduction data sets, also called coupons. The price reduction data sets contain a price reduction data set identifier (ID), a designator, a discount in the form of a percentage or an amount in a predefined currency, information on a period of validity and optionally further text information and images as well as a point of sale receipt text. Since the promotion server can store the coupons of several retailers or bonus program suppliers, it also contains a data structure, for example, a table which assigns the price reduction data set identifiers of various retailer identifiers. Furthermore, each price reduction data set can be assigned an internal customer identification code, i.e. not known to the point of sale device and the retailer. For example, the promotion server contains a table with price reduction data sets and an assignment table in which the internal customer identification codes are listed and these are each assigned a number of price reduction data set IDs. From the promotion server 24 the point of sale data processing device 2 receives price reduction data sets which each identify a price reduction of an article associated with an article identifier.

The point of sale data processing device 2 is connected via a further communication connection 13 to a further server 25 within the DMZ, where this further server should here be designated as payment server. The payment server 25 contains data from the point of sale data processing device 2 which are required for a cashless payment transaction such as, for example, a customer identification and so-called point of sale receipt data, that is data which characterise the content of a proof of purchase, i.e. article identification and individual prices and calculated price reductions, totals, value added tax and similar. The payment server 25 in turn communicates via another external connection 17, also protected by firewalls 19, with a computer 18 of a so-called payment provider which provides for the actual payment transaction. As soon as the payment server 25 establishes as a result of its communication with the external payment provider and as a result of further communication with other servers inside the DMZ, that the payment transaction requested by the point of sale data processing device can be performed, the payment server 25 informs the point of sale data processing device 2 via the communication connection 13 that the payment is successful. The communication of the payment server 25 with the point of sale data processing device 2 on the one hand and with the computer 18 of the external payment provider on the other hand will not be explained in detail here since this is not essential for the invention.

The communication connections 12 and 13 shown separately in FIG. 1 are logically separate connections but can naturally also be executed physically via the same data line and via an arbitrary data communication network, for example, via the internet. The communication connections 12 and 13 are preferably VPN connections which use the IP.

When a customer would like to make a payment at the point of sale 1, the point of sale data processing device 2 coupled to the promotion server 24 via the communication connection 12 receives a recorded external customer identification code of the customer via the input devices 3. The recorded external customer identification code is sent via connection 12 to the promotion server 24. The promotion server 24 determines a relevant first internal customer identification code and price reduction data sets associated with this using the received external customer identification code. The promotion server 24 then sends the price reduction data sets back to the point of sale data processing device 2. These price reduction data sets, each identifying a price reduction of an article associated with an article identifier, are taken into account by the point of sale data processing device 2 when calculating the amount to be paid. The promotion server 24 stores a plurality of price reduction data sets each associated with a customer identification code. In the preferred embodiment of the point of sale system, the promotion server 24 transmits all the price reduction data sets associated with the customer identification to the point of sale data processing device 2 and specifically regardless of which article the customer purchases at the point of sale 1. The point of sale data processing device 2 then compares the article identifiers of the price reduction data sets with the article identifications of the articles to be purchased recorded at the point of sale. As soon as an agreement is established between a purchased article and an article identifier of a received price reduction data set, the percentage or absolute amount specified by the received price reduction data set is directly and automatically taken into account when calculating the total amount to be paid. Price reduction data sets with article identifiers which do not correspond to any purchased article are therefore unused price reduction data sets and are transmitted back to the promotion server 24 after the purchase transaction via the connection 12.

The data processing system 20 comprises a server 22 which is designated as an application server. This application server records and stores customer data of customers who have a mobile telephone on the one hand or a similar mobile data communication device and on the other hand can access the internet either via the mobile telephone or—usually—via a computer. Customers have the possibility of making cash-less payments, but without money or credit cards, simply with the aid of the mobile telephone at those points of sale in shops which provide the functionality required for this. This payment with the aid of the mobile telephone of a customer is made by on the one hand the point of sale device 1 receiving an identification of the customer and on the other hand the mobile telephone 9B receiving authorisation data from the application server 22 via a secured wireless communication connection 15 (for example, https encrypted) and also passes this authorisation data to the point of sale device 1. The user identification and the relaying of the authorisation data in the point of sale device 1 can for example, by accomplished via the aforementioned near-field communication (NFC). However, it is also feasible that certain codes are displayed on the display of the mobile telephone 9A, which are then input manually via the keypad 5 of the point of sale device. Using the user identification and the authorisation data, the point of sale data processing device 2 then communicates via the connection 13 with the payment server 25 so that a payment transaction is made as a result of this communication. The possibility of payment using a mobile telephone will not be described in further detail here since it is not the subject matter of the present invention.

As already mentioned, the application server 22 records customer data such as, for example, a name and an address as well as bank account connection and assigns the customer an internal customer identification code. This internal customer identification code can, for example, be the same code which is assigned to the price reduction data set identifiers in the afore-mentioned promotion server 24. In a preferred embodiment the bank connection data of the customer are not stored in the application server 22 and not on another server of the data processing system 20; instead the bank connection data are deposited at a payment provider which assigns a unique payment provider customer number and returns it to the application server operator so that this payment provider customer number, optionally together with an identification of the payment provider (instead of the bank connection data) can be assigned to the internal customer identification code in the application server 22. In order that the application server can record the required data from the customer, the customer makes a connection 16 (for example, also https encrypted) starting from his computer 10 to a portal server 23. The portal server 23 provides the functionality connected with the internet presence, among other things an input mask which is generated on the screen of the computer 10 of the customer. The customer is thereby requested to input the necessary customer data.

The portal server 23 then relays the customer data via the connection 31 to the application server 22 which records the customer data in a database. For protection of the data processing system 20 the communication connection 16 between the computer 10 of the customer and the portal server 23 has one or more firewalls inside the DMZ.

The communication connection between the computer 10 of the customer via the connection 16 to the portal server 23 and further via the connection 31 to the application server 22 is not only used to record customer data; via this access, it is also possible for the customer to observe various data on his computer 10 which are related to the purchase and the payment via his mobile telephone. For example, after completion of the purchase, the point of sale data processing device 2 of the point of sale device 1 transits a point of sale receipt (i.e. point of sale receipt data) to the payment server 25, where the data of the point of sale receipt are relayed via the connection 29 to the application server 22. It is then possible for the customer to view his point of sale receipt on his computer 10 when he calls up a corresponding menu which provides access to the point of sale receipt data in the application server 22. It is therefore possible for the observe on his own computer 10 when he has purchased which article in which shop.

Furthermore, the point of sale system according to the invention provides that the customer compiles shopping lists (“shopping slips”) on his computer 10 in which he records goods (articles) which he would like to purchase in the near future. These shopping lists comprise, for example, tabular data structures of article designations, possibly quantitative details. In this case, the information of the customers does not need to correspond to the exact article designations. Frequently, the customer will simply input broad terms such as “bread”, “10 rolls”, “fruit”, or “toothpaste”. These “shopping lists” are stored in association with the internal customer identification code in an area of the application server 22 which in principle only the customer can access. However, during or after entering his shopping lists on his computer 10, it is possible for the customer to specify whether he would like to make the data of the shopping lists available to third parties or not, where the customer knows that when providing this to third parties, only the article-related data of the “shopping lists” is passed on but not the customer data; the customer remains anonymous. If the customer selects this possibility for releasing the data of his shopping list, the article-related data of the shopping lists are made available to an evaluation program. This evaluation program which, for example, is transacted on the application server 22, analyses the shopping lists of the customers who have allowed or released this analysis or evaluation and derives article identification data from this which is provided for access by third parties (i.e. discount provider—see below). The derived article identification data can, for example, comprise lists of all the article designations appearing on the shopping lists, where these for example can be shown arranged, for example, according to the frequency of their occurrence. Furthermore article identification data are available in which it is specified which articles appear frequently in combination with which other articles on the shopping lists.

Possible interested parties for such anonymized article identification data are, for example, discount providers, where discount providers should be understood here as any organisation which offers a bonus program. These can be manufacturers which offer discounts or bonuses for their products. These can be retailers; however this can also be pure bonus program providers who cooperate with a plurality of retailers or manufacturers. In order that these third parties have no direct access to the application server 22 storing the customer data, the data processing system 20 contains another server, the so-called back office server 21. Via the communication connection 26 the application server 22 transmits to the back office server 21 the article identification data derived from the article lists of the customers, for example, list evaluations, which specify the frequency of the article designation contained in the article lists (that is “shopping lists”). A data processing device 11 of a discount provider can then access the back office server 21 via a communication connection 14. For this purpose the data processing device 11 of the discount provider contains a so-called back office client. Naturally the data processing system 20 is also protected by firewalls 19 in this communication connection 14.

FIG. 2 shows a screen shot such as could appear, for example of the screen of the data processing device 11 of the discount provider during access to the back office server 21. This screen show contains a menu 35 on the left-hand side, where the menu point “shopping lists” 36 is selected here. When selecting the menu point “shopping lists” 36, a table “evaluation shopping list articles” 37 appears on the right-hand side of the screen. The table 37 contains an evaluation as to how often which article designation appears on the shopping lists of the customer. The first column 38 contains frequency information and the second column 39 the article designation. In the first line, it is indicated that the article designation “spaghetti” has appeared a total of 70542 times. In the penultimate line the number “24525” is given in the first box 40 and the designation “apples” in the second box 41. This means that the designation “apples” has appeared as total of 24525 times. By making this information available to the discount providers, the latter can plan targeted marketing campaigns, for example, targeted coupons, that is provide discounts for those products which appear frequently on the shopping lists and therefore will soon be purchased frequently by the customers.

In another screen mask—not shown here—which is generated on the screen of the discount provider during communication between the data processing device 11 and the back office server 21, employees of the discount provider can generate coupons, that is data from price reduction data sets. This means that the back office server 21 receives data from the data processing device 11 via the communication connection 14, which specifies price reductions of specific articles where these articles can in particular be articles contained in the article lists (that is the shopping lists of the customers). The back office server 21 processes these data and then transmits these data via the communication connection 28 to the promotion server 24, which stores this in the form of the aforesaid price reduction data sets. In other words, depending on the inputs of the discount provider on its data processing device 11, the back office server 21 generates coupons and transmits these for storage on the promotion server 24. This is accomplished at the same time or successively for a number of discount providers, who access the back office server 21 via different communication connections 14. The price reduction data sets of the different providers are stored on the promotion server 24, naturally with an identification of the provider. The price reduction data sets generated in this way by the back office server 21 on the promotion server 24 however have no association with any of the customers.

In order to produce this association of the price reduction data sets on the promotion server 24 with the customers (so that the customer can also enjoy the coupon when making payment at the point of sale), it is necessary to associate the internal customer identification codes with the price reduction data sets (coupons) on the promotion server 24. This is accomplished as a result of a communication between the promotion server 24 and the application server 22 via the connection 30 and a further communication between the mobile telephone 9B with the application server 22 via the connection 15 or a further communication between the computer 10 of the customer with the application server 22 via the connection 16, the portal server 23 and the connection 31. For association of the customer identification codes with the coupons stored in the promotion server 24, it is initially necessary for the customer to call up an application program on his mobile telephone 9B (or on his computer 10), which displays information to him about the available coupons, that is about the price reduction data sets stored on the promotion server. As soon as the customer calls up this application, this is transmitted to the application server 22 which thereupon retrieves the available price reduction data sets via the communication connection 30 and displays information contained therein (after a suitable data preparation) on the display of the mobile telephone 9B or on the screen of the computer 10, In one embodiment the customer could then select coupons which he wants, this selection input of the customer in turn being transmitted to the application server 22 which thereupon ensures that in the promotion server 24 the internal customer identification code is assigned to the affected price reduction data sets of the coupons selected by the customer. In an alternative preferred embodiment it is provided that the customer merely retrieves a listing of all the coupons or information about the existence of coupons, information about all the available coupons are then displayed to him on the mobile telephone or the computer and the customer identification code is then assigned to all the available coupons or price reduction data sets on the promotion server 24 without the customer needing to select coupons beforehand.

Alternatively or additional, the following procedure is also feasible when assigning a customer identification to the price reduction data sets (coupons) stored in the promotion server 24. After the customer has been shopping (somewhere), the point of sale receipt point of sale receipt data are firstly made available to the payment server 25 and then to the application server 22. The application server 22 then communicates via the connection with the promotion server 24, where it informs the promotion server that the customer (who is identified by a certain customer identification code) has purchased certain articles. If price reduction data sets (coupons) for these articles are present in the promotion server 24, the customer identification code is assigned to these price reduction data sets. This means that the assignment of the customer identification code to a price reduction data set, that is the activation of the price reduction data set, is not dependent on the observation of this price reduction data set (coupon) by the customer but rather on the previous purchase of a corresponding article. The customer then receives, for example, via SMS a message that new coupons are available for him. He can then view these on the screen of his computer or on the display of his mobile telephone. This message transmitted, for example, by SMS can be associated with a message which for example reads: “many thanks for your purchase at . . . (name of retailer). As a thank you new coupons are available exclusively for you and you can get information on these by means of our coupon manager”.

It is also feasible that the provision or activation of the coupons in the promotion server 24 is dependent on a cumulative fulfilment of the conditions for previous purchase of a certain article and previous viewing of the coupons by the customers. In addition, a number of other transaction-dependent conditions are feasible which can lead to activation of coupons in the promotion server 24, i.e. for the assignment of customer identification codes.

As soon as the price reduction data sets or coupons are activated on the promotion server 24, that is a customer identification code is assigned to them, the customer can use these coupons on his next purchase. If the customer comes to the point of sale 1 for the purpose of payment and has transmitted his customer identification code to the point of sale, the data processing device 2 of the point of sale 1 communicates via the connection 12 to the promotion server 24 in order to retrieve from these all the coupons assigned to the customer. To this end the data processing device 2 transits the received external customer identification code to the point of sale 1. The promotion server 24 receives this external code and calculates from this the internal customer identification code (which may not be known to the point of sale 1). The promotion server 24 then has a look to see which coupons are assigned to this customer identification code. The coupons are then transmitted to the data processing device 2. The data processing device 2 then compares the article identifiers of the price reduction data sets with the article identifications of the purchased goods (whose barcodes have just been scanned for example). As soon as an article is found for which a coupon exists, the relevant discount is taken into account when calculating the amount to be paid. Coupons with article identifiers which do not correspond to any purchased articles remain unused and are sent back to the promotion server 24 after completion of the purchasing transaction (in fact, naturally only the information as to whether a coupon was used or not is sent so that the promotion server 24 can update its database accordingly).

1-16. (canceled)

17. A point of sale system for retail, comprising:
at least one point of sale device of a retailer comprising a point of sale data processing device and input devices for recording an external customer identification code and recording an article identification of at least one article, wherein the point of sale data processing device calculates an amount to be paid as a function of the at least one recorded article identification; and
a data processing system coupled to the point of sale data processing device via a data transfer network, that receives an external customer identification code recorded by the point of sale data processing device, determines price reduction data sets using the received customer identification code, which each identify a price reduction of an article associated with an article identifier, and sends these price reduction data sets back to the point of sale data processing device, so that the point of sale data processing device takes into account the received price reduction data sets when calculating the amount to be paid;
wherein the data processing system comprises:
a first server device which
stores price reduction data sets containing price reduction data set identifiers which can each be associated with one or more first internal customer identification codes, wherein the first internal customer identification codes are the same as the external customer identification codes or can be calculated uniquely from these,
receives the recorded external customer identification code via the data transfer network,
determines the relevant first internal customer identification code and relevant price reduction data sets using the received external customer identification code, and
sends the price reduction data sets back to the point of sale data processing device; and
a second server device coupled to the first server device, which
records customer data comprising article lists associated with the customer which identify the articles desired by the customer, and assigns a second internal customer identification code to the customer data,
derives article identification data from the article lists and makes these data available for access by a data processing device of a discount provider, without allowing said discount provider access to the customer data and the second internal customer identification code,
receives data from the discount provider which specifies price reductions of at least one article, which corresponds to an article contained in the article list,
transmits the data specifying the price reductions associated with data identifying the affected articles to the first server device which stores these data as price reduction data sets and
causes the price reduction data sets stored in the first server device to be associated with first internal customer identification codes wherein said server device derives the first internal customer identification codes from the second internal customer identification codes;
wherein the first server device can only be accessed by the second server device and point of sale data processing device.

18. The point of sale system according to claim 17, wherein identifiers of associated retailers are additionally associated with the price reduction data sets, wherein in addition to the external customer identification code, the first server device also receives an identifier of the retailer from the point of sale data processing device and the price reduction data sets to be sent back to the point of sale data processing device are also determined using the received identifier of the retailer, and
wherein in addition to the data specifying the price reductions, the second server device additionally receives data from the discount provider, which specifies associated retailers and transmits the data specifying price reductions also associated with data identifying the associated retailer to the first server device.

19. The point of sale system according to claim 17, wherein the first internal customer identification codes are identical to the second internal customer identification code and the internal customer identification code can be calculated uniquely from the external customer identification codes.

20. The point of sale system according to claim 19, wherein the external customer identification codes are derived by encryption from the internal customer identification codes.

21. The point of sale system according to claim 17, wherein the first server device receives no recorded article identifications from the point of sale data processing device and using the received external customer identification code, determines all the associated price reduction data sets independently of the associated article identifiers and sends these data sets back to the point of sale data processing device.

22. The point of sale system according to claim 17, wherein the second server device causes first internal customer identification codes to be associated with the price reduction data sets stored in the first server device, whereby the second server device retrieves the price reduction data sets and makes information contained therein available to a customer for retrieval so that the customer can observe this information on a data communication device coupled to the second server device and in response to the retrieval of the information by the customer transmits the first or second internal customer identification code to the first server device and causes this to assign first internal customer identification codes to the price reduction data sets.

23. The point of sale system according to claim 17, wherein the data processing system comprises a third server device, wherein the third server device receives the external customer identification code and point of sale receipt data from the point of sale data processing device, which identify the purchased articles and the purchase price paid, and passes the point of sale receipt data associated with the customer identification code to the second server device.

24. The point of sale system according to claim 23, wherein the second server device causes first internal customer identification codes to be associated with price reduction data sets stored in the first server device, whereby the second server device compares the data identifying the purchased articles of the point of sale receipt data received from the third server device with the article identifiers of price reduction data sets of the first server device and if the identified articles agree, retrieves the price reduction data set and makes the information contained therein available to a customer for retrieval, so that the customer can observe the content of the price reduction data sets on a data communication device coupled to the second server device and can select the desired price reduction data set and transmits price reduction data set identifiers of the price reduction data sets selected by the customer together with the first or second internal customer identification code to the first server device and causes this server device to associate first internal customer identification codes with the corresponding price reduction data sets.

25. The point of sale system according to claim 17, wherein the first and the second server devices are disposed within an access-protected computer network (DMZ) and the data processing device of the discount provider is disposed outside the access-protected computer network.

26. The point of sale system according to claim 17, wherein the input devices for recording the external customer identification code comprise a scanner which reads a barcode representing the external customer identification code produced on a mobile communication device of the customer.

27. The point of sale system according to claim 26, wherein the scanner is used for recording the external customer identification code and for recording the article identification.

28. The point of sale system according to claim 17, wherein the input device for recording the external customer identification code comprise an NFC communication device which executes a near field communication (NFC) with a mobile communication device of the customer which stores the external customer identification code.

29. The point of sale system according to claim 17, wherein the second server device is connected to a data processing device of the customer via a data telecommunications network, of which the second server device receives customer data, wherein the customer data comprises data which identify articles desired by the customer.

30. The point of sale system according to claim 29, wherein the second server device is connected to a mobile communication device of the customer via a data communication network, from which the second server device can receive data which identifies articles desired by the customer and to which the second server device can transmit data which identifies articles desired by the customer, wherein these data can be exchanged in such a manner that the data which is stored and can be displayed in the mobile communication device, which identifies articles desired by the customer agrees with the list of articles stored in the second server device.

31. The point of sale system according to claim 17, wherein the second server device records an identifier by which means it is indicated whether the customer has released or blocked a relaying of the article list data to the discount provider and
that the second server device only provides article identification data derived from the article lists for access by a data processing device of the discount provider when the identifier releases this.

32. The point of sale system according to claim 17, wherein the second server device comprises at least two servers, wherein a first server of the second server device records the customer data with the article lists and assigns the second internal customer identification codes and causes first internal customer identification codes to be associated with the price reduction data sets stored in the first server device and wherein a second server of the second server device provides the article identification data for access by a discount provider, receives data specifying price reductions from the discount provider and transmits these data specifying price reductions to the first server device.
